(19) United States
(12) Patent Application Publication
(10) Pub. No.: US 2010/0147239 A1
(43) Pub. Date: Jun. 17, 2010

(54) IGNITION ARRANGEMENT

(76) Inventors: Hang Lu, Kufstein (AT); Markus KRAUS, Wiesing (AT)

Correspondence Address: WENDEROTH, LIND & PONACK, L.L.P., 1030 15th Street, N.W.,, Suite 400 East, Washington, DC, 20005-1503, US

(21) Appl. No.: 12/638,150

(22) Filed: Dec. 15, 2009

(30) Foreign Application Priority Data
Dec. 16, 2008 (AT) A 1957/2008

(51) Int. Cl. H01T 13/08

(52) U.S. Cl. 123/169 R

(57) ABSTRACT

An ignition arrangement for a combustion machine, which provides a corona discharge for ignition of a fuel/air mixture in the combustion chamber (24) of the combustion machine, wherein the ignition arrangement delivers a basic voltage U_{L} which is always different from zero for triggering and maintaining the corona discharge for each ignition process.

The invention concerns an ignition arrangement for a combustion machine, which provides a corona discharge for ignition of a fuel/air mixture in the combustion chamber of the combustion machine. The invention further concerns a method of igniting a fuel/air mixture, preferably in the combustion chamber of a combustion machine, by means of a corona discharge. Finally the invention concerns a combustion machine as well as a stationary power installation having such an ignition arrangement.

Various technologies are used for the ignition of combustion machines operated on the basis of the Otto cycle. For the predominant part ignition is effected by means of so-called spark ignition systems. Because of rising demands for optimisation of combustion, besides that option, other technologies such as for example diesel pilot, laser or corona ignition have also been developed and used in high-performance engines.

In corona ignition arrangements the fuel/air mixture is ignited in the combustion chamber of the combustion machine by high electrical field strengths, but without arc discharge. In contrast to spark ignition systems, in the corona ignition arrangement only a glow discharge is allowed, but not the production of an arc discharge. Reference is made to arc discharge when a flashover occurs with the production of an electrical ignition spark between the electrodes. Corona discharge is therefore a state in which partial discharges occur in the air path between two electrodes, these being expressed in short high-frequency current peaks. No permanent flow of current however is generated. Shortly before the breakdown between the two electrodes, the partial discharges very frequently occur. In the breakdown a continuous flow of current is produced between the two electrodes. In that case ions which are produced by a plasma around at least one of the electrodes act as charge carriers. A fluid is therefore ionised, surrounding an electric conductor.

For a corona ignition arrangement, usually an electrode which is preferably in the form of a point or is formed with a plurality of points is used in the region of each cylinder head of the combustion machine to generate the required field strengths. Generally the combustion chamber of the cylinder itself is used as the counterpart pole. The piston and the underside of the cylinder head form the ground electrode for such corona ignition arrangements.

U.S. Pat. No. 6,883,507 to Paul Douglas Freen describes an ignition arrangement for a combustion machine, which provides a corona discharge for the ignition of a fuel/air mixture in the combustion chamber of the combustion machine. In that case an AC voltage at between 30 kHz and 3 MHz is produced. U.S. Pat. No. 5,649,507 also affords an ignition arrangement of the general kind set forth. A voltage which comprises only the positive sine waves of an ac voltage is provided for the ignition process.

To optimise the working range of corona discharge it is necessary to prevent the occurrence of the arc discharge. The voltage range is therefore limited by a lower voltage which must be sufficiently high to excite the electrons and an upper voltage which leads to the arc discharge. Arc discharge can be prevented by virtue of the fact that on the one hand that upper voltage limit is not exceeded or the time is too short for generation of the arc discharge. In that case, when using ac voltage sources, there is a limitation in respect of voltage or time, as on the one hand the voltage peak value must be kept below the breakdown to arc discharge while on the other hand the time of charge reversal cannot be utilised. A further complication is that the limit for arc discharge and for generation of a corona discharge is dependent on polarity.

The ignition arrangements used in the state of the art suffer from the disadvantage that the energy introduced for ignition of the fuel/air mixture is not put to optimum use.

Therefore the object of the present invention is to provide an ignition arrangement of the general kind set forth in the opening part of this specification, with which those problems are reduced.

That object is attained by an ignition arrangement, preferably a corona ignition arrangement, for a combustion machine, which provides a corona discharge for ignition of a fuel/air mixture in the combustion chamber of the combustion machine, which is characterised in that the ignition arrangement delivers a basic voltage U_{L} which is always different from zero for triggering and maintaining the corona discharge for each ignition process.

In tests it has been found that the optimum energy input is achieved if the voltage is continuously kept at the limit shortly before arc discharge. It is essential in that respect that the basic voltage available is always different from zero for triggering and maintaining each individual corona discharge. That means that, in contrast to an ac voltage, there is no zero crossing or, in contrast to the arrangement of U.S. Pat. No. 5,649,507, the voltage at the electrode never falls to zero over a prolonged period of time. More specifically in the state of the art on the one hand there are losses caused by charge reversal at the electrodes. Below the ‘corona limit’ the corona collapses during charge reversal and has to be subsequently restored when the corona limit is reached again. On the other hand, when using a basic voltage which is always different from zero, it is possible to go closer to the breakdown limit in relation to arc discharge as polarity effects no longer occur, due to pole reversal at the electrodes, so that the effectiveness of energy input is increased. It is therefore preferably provided that the basic voltage which is different from 0 is always kept above the corona limit.

A preferred variant provides that the ignition arrangement is characterised by a transformer, wherein provided on the primary side of the transformer is a voltage source which delivers alternating current or a varying dc voltage. In that respect the term varying dc voltage is used to denote such a dc voltage which changes in its magnitude in dependence on time. In the simplest case there is provided a conventional alternating current source which generates a sinusoidal or square-wave voltage.

To be able to use a small voltage source on the primary side, it can desirably be provided that a voltage multiplier is provided on the secondary side of the transformer.

To keep the voltage on the secondary side substantially constant, it can be provided that a voltage smoother is arranged on the secondary side of the transformer.

In the simplest case it can be provided in that respect that the voltage smoother is a half-wave smoother. For example a so-called smoothing capacitor is appropriate here. For more complicated and expensive applications it has proven to be advantageous if the voltage smoother is a multi-wave smoother.

For a particularly optimum corona discharge it can be provided that the control device and/or regulating device keeps the voltage U_{L} at the electrode in the combustion chamber substantially constant. Here on the one hand in the simplest case there can be provided a control device with which the voltage is kept at a substantially constant value. In order to be even better capable of taking account of interference influences, there can be provided a regulating device which keeps the voltage on the secondary side of the transformer substantially constant. For that purpose the voltage is ideally re-regulated to a reference value which is ascertained for example in dependence on different engine parameters. In that respect it can be provided that the at least one engine parameter is selected from the group of ignition time, ignition duration or combinations thereof. The ignition arrangement can be of such a design that the control device and/or regulating device always keeps the basic voltage U_{L} below the breakdown voltage U_{B} for an arc discharge. In addition the ignition arrangement can be so designed that the control device and/or regulating device always keeps the basic voltage U_{L} above the corona limit U_{K}.

In that respect in the simplest case the ignition arrangement is so designed that an electrode is provided at the secondary side, the electrode extending into the combustion chamber of the combustion machine. The basic voltage which is different from zero is applied at that electrode. The counterpart electrode can also extend into the combustion chamber. It will be noted however that the counterpart electrode can also be formed by the combustion chamber itself, for example by way of the piston and/or underside of the respective cylinder head.

Besides the above-described ignition arrangement the foregoing object is self-evidently also attained by a corresponding method. In such a method of igniting a fuel/air mixture, preferably in the combustion chamber of a combustion machine, by means of a corona discharge, it is provided that a basic voltage U_{L} which is always different from zero is provided for triggering and maintaining the corona discharge. The further configurations of the method follow substantially from the above-described ignition arrangement and the specific description hereinafter.

In a further aspect of the invention there is provided a combustion machine having an ignition arrangement of the aforementioned kind. There is further provided in accordance with the invention a stationary power installation comprising a generator, a combustion machine and an ignition arrangement of the aforementioned kind. In the preferred case the combustion machine is a stationary combustion machine as are used for example in stationary power installations. Stationary power installations generally have a combustion machine and an electric generator for electric current generation.

Furthermore the preferably stationary combustion machine can be a gas engine, that is to say an internal combustion engine which burns a gaseous fuel such as methane. Preferably this involves a mixture-charged gas engine. In mixture-charged gas engines, it is not pure air but a fuel-air mixture that is compressed in the compressor devices, as a fluid. Gas engines are particularly well suited for ignition arrangements with corona discharge.

Further advantages and details of the invention are set forth with reference to the specific description and the following Figures in which:

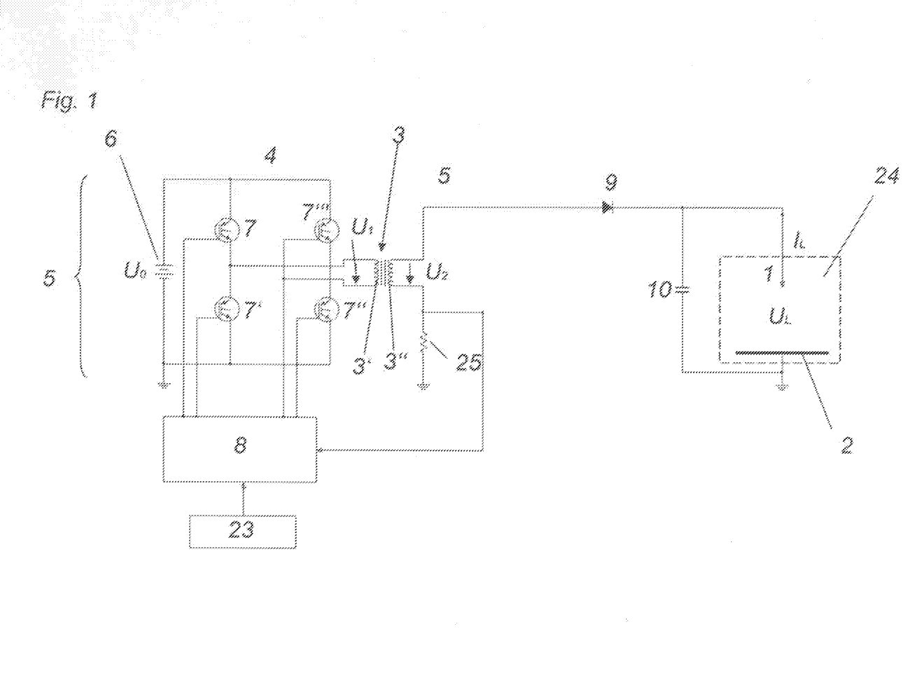

FIG. 1 shows a circuit diagram of a first ignition arrangement according to the invention,

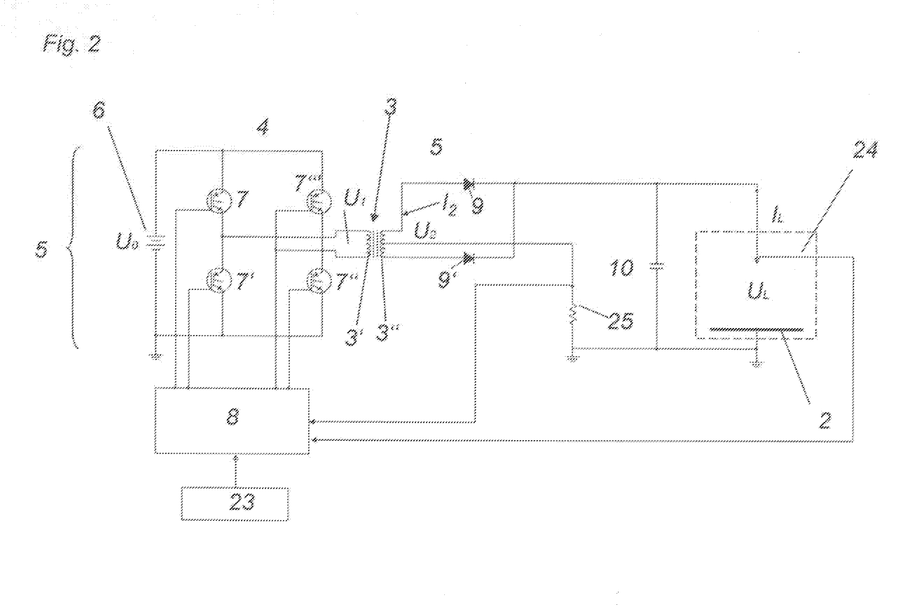

FIG. 2 shows a second variant of an ignition arrangement according to the invention,

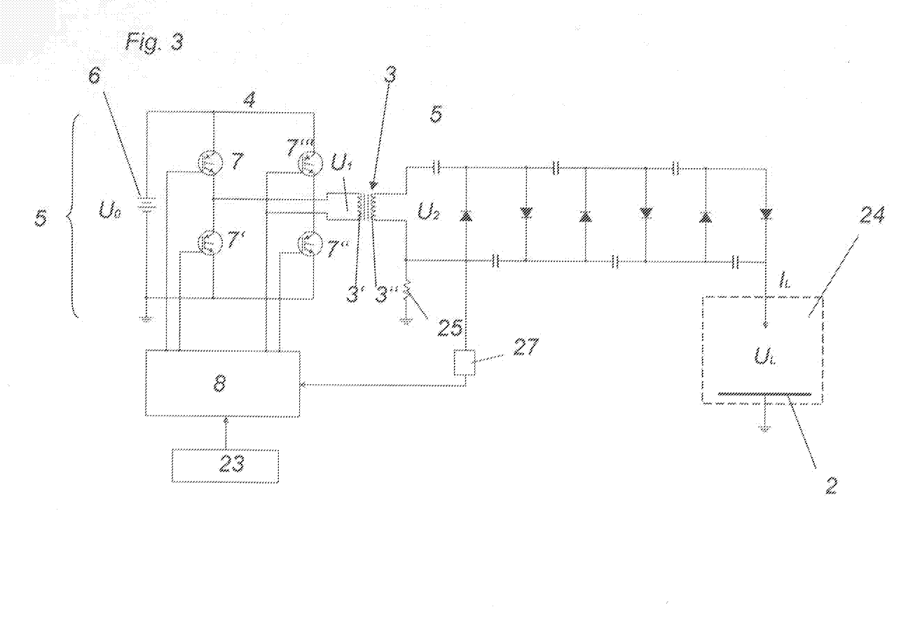

FIG. 3 shows a third variant of an ignition arrangement according to the invention,

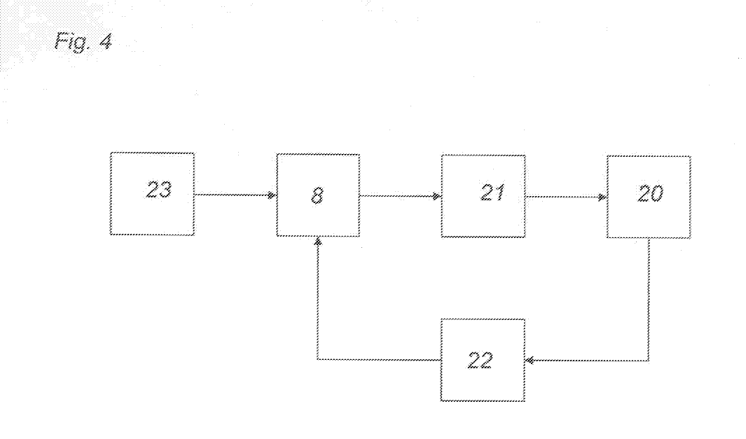

FIG. 4 shows a block diagram of a regulating circuit for an ignition arrangement according to the invention,

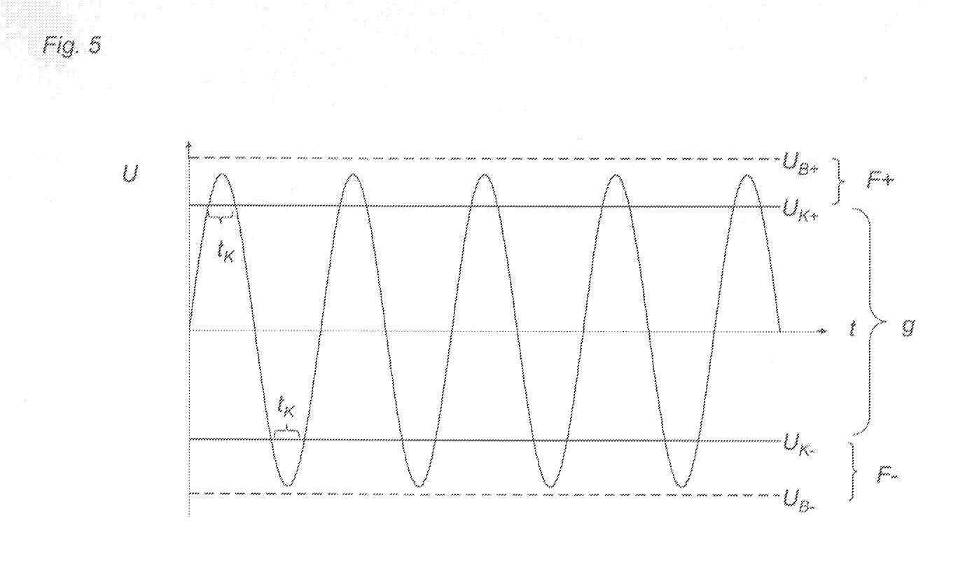

FIG. 5 shows a diagram demonstrating the improved energy input, and

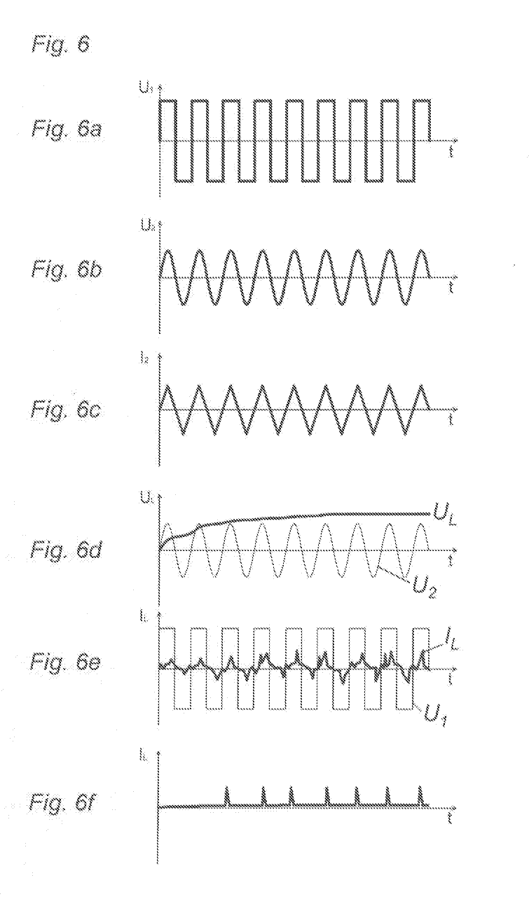

FIG. 6 shows the variation in respect of time of various voltages and current strengths by means of the example of the ignition arrangement shown in FIG. 3.

FIG. 1 diagrammatically shows an ignition arrangement for a combustion machine according to the invention. In this case there is provided a first electrode 1 which extends into the combustion chamber diagrammatically indicated (in broken line) of the combustion machine. The counterpart electrode 2 is formed at least partly by the combustion chamber 24 or the walls of the combustion chamber 24. A corona discharge is produced between the electrode 1 and the counterpart electrode 2 within the combustion chamber 24. In that respect, firstly for triggering and then for maintaining the corona discharge within the combustion chamber for each ignition process the ignition arrangement delivers a basic voltage U_{L} which is always different from zero over the entire time duration of the corona discharge. For that purpose a voltage source 5 is provided on the primary side 4 of the transformer 3. The voltage source has a DC voltage source 6 and a plurality of thyristors 7, 7′, 7″, 7′″. A clock-controlled ac voltage is produced by switching of the transistors 7, 7′, 7″, 7′″, by means of a regulating device 8, from the dc voltage of the dc voltage source 6. It is provided in that respect that the voltage generated is converted into an ac voltage at a frequency of between about 150 and 200 kHz. As already indicated, the actual electrode 1 and the counterpart electrode 2 are provided on the secondary side 5 of the transformer 3. Rectification of the voltage is achieved by means of the diode 9 and the capacitor 10. The capacitor 10 and the diode 9 jointly form a half-wave smoother, the capacitor 10 serving as a smoothing capacitor. The ignition arrangement therefore has a dc voltage source, for example a battery, of a voltage U₀. An AC voltage U₁ is produced from the dc voltage U₀ by way of the regulating device 8 and the thyristors 7, 7′, 7″, 7′″ which jointly with the dc voltage source 6 form the voltage source 5. The transformed voltage U₂ is afforded by way of the transformer 3 and the turns ratio n₁/n₂ of the primary coil 3′ and the secondary coil 3″. The diode 9 and the capacitor 10 make out of the ac voltage U₂, a dc voltage U₁ which is applied at the electrodes 1, 2. An additionally provided regulating device 8 detects the secondary current I₂ by way of the resistor 25 at the secondary side 5 of the transformer 3. At the same time the regulating device 8 detects various engine parameters. The primary voltage U₁ can be so re-adjusted by way of a closed regulating circuit, by way of the actuation of individual thyristors 7, 7′, 7″, 7′″, that the secondary voltage U₂ is re-set to its reference value. For more accurate regulation recourse is made to additional engine parameters 23.

A fuel/air mixture is let into the combustion chamber 24 at the beginning of the ignition process and compressed by way of a piston stroke. For ignition purposes the voltage U_{L} is built up and maintained over the entire ignition process and post-regulated with the regulating device 8. A corona discharge is formed, with a simultaneous current flow I_{L}. The corona discharge is maintained until a stable flame core has formed. The voltage U_{L} is then switched off.

Unlike the FIG. 1 embodiment the embodiment in FIG. 2 now has not only a half-wave smoother but a multi-wave smoother. By virtue of the two diodes 9, 9′ and the capacitor 10 it is in the form of a center-point rectifier. A variant (not shown) could also be in the form of a full-wave rectifier, by way of a bridge rectifier.

A regulating unit 8 is additionally provided both in the FIG. 1 embodiment and also the FIG. 2 embodiment. It will be noted however that this is only optionally provided. With a known voltage characteristic U_{L} at the electrodes 1, 2 over the entire ignition process, a simple adjusting mode can also be provided. In that case the voltage U_{L} is simply only kept at a given value. In the example in FIG. 2 the voltage U_{L} is additionally used as a variable for regulation.

While the voltage U₂ at the secondary side 5 only occurs by way of the number of turns of the respective coil 3′, 3″ at the transformer 3, the embodiment of FIG. 3 additionally uses a voltage multiplier 26 on the secondary side 5 of the transformer. For that purpose, the assembly has a so-called high-voltage cascade which can have a plurality of stages. The illustrated embodiment involves a three-stage cascade, with which the voltage at the secondary side 5 can be theoretically trebled. In practical variants high-voltage cascades with between 3 and 5 stages have proven to be advantageous. The other components and the regulating system are based on FIGS. 1 and 2.

The following values were achieved in practical examples: the primary voltage of the ignition coil U₁ was between 100 and 500 V, the secondary voltage of the coil U₂ was in the range between 5 and 100 kV, preferably between 5 and 30 kV. The ac voltage for feeding the cascade circuit was in frequency ranges between 50 and 500 kHz. The rectified ignition voltage U_{L} reaches values of between 10 and 100 kV by virtue of amplification and conversion in the cascade circuit.

FIG. 4 diagrammatically shows the mode of operation of the regulating device 8. The central component in that respect is the regulating device 8 which on the one hand is supplied with certain engine parameters 23, for example ignition parameters such as ignition time and ignition duration. The regulating device also receives information by way of voltage measurement at the secondary side between electrodes 1 and 2 by way of a filter 22 from the corona path 20. Actual regulation is effected by adjusting variable adjustment by way of the power circuit 21 on the primary side 4 of the transformer 3.

FIG. 5 shows a diagram in respect of voltage U as a function of time t. The voltage configuration (in the form of a sine curve) occurring at the electrode 1 in a corona ignition arrangement in accordance with the state of the art is illustrated, during the ignition process. Firstly the voltage is built up until the corona limit U_{K+} is reached, above which corona discharge occurs in the combustion chamber. (At this juncture it should be noted that, in relation to the voltages, it is always the magnitude of the voltage, that is to say without the respective sign, that is meant, when reference is made to ‘above’ or ‘below’). It will be noted that the maximum voltage must be kept below the breakdown limit for the arc discharge U_{B+}. The voltage then falls again and drops below the corona limit U_{K+}, performs a 0-crossing and continues further until the lower corona limit U_{K-} is reached so that a corona is again generated. Here too the magnitude in relation to the breakdown voltage for the corona discharge U_{B-} may not be exceeded. The magnitudes of the voltages U_{B+} and U_{B-}, U_{K+} and U_{K-} are different by virtue of polarisation effects. In addition that gives rise to corona windows F+ and F− respectively of different heights, in which the corona discharge can take place. The actual energy input into the combustion chamber is proportional to the integral over the respective period t_{K} of a corona window in which a corona discharge takes place. The remaining time does not involve any energy input and polarity reversal of the electrodes remains unused in the region g between U_{K+} and U_{K-}. Added to that is the fact that, by virtue of polarisation effects, the spacing between the extreme positions of the sine curve in relation to the respective breakdown voltage U_{B} for the arc discharge U_{B+} and U_{B-} is different so that the amount of energy introduced can only be optimised for one polarity (plus or minus) (here: to the lower part of the sine voltage). In the case of rectified voltages where only one half-wave of the voltage is ‘cut off’, at least the losses between 0 and the corona limit U_{K+} and U_{K-} (depending on which respective half-wave is cut off) would have to be accepted. By always keeping the basic voltage U₀ above the corona limit U_{K} (depending on the respective polarity), the energy losses can be minimised and optimally approach the limit for the breakdown voltage for the arc discharge U_{B} and always remain in the corona window F+ and F− respectively.

FIG. 6 shows the time variations in the most important signals (voltages and current strengths) for the corona ignition arrangement in FIG. 3. In this case mutually superposed FIGS. 6a through 6f each show mutually associated values. The illustrated period of time is that for one ignition process. Such a process should be concluded within about 2 ms, preferably within between 500 μs and 1 ms so that optimum ignition of the fuel/air mixture occurs. It is possible to see from FIG. 6a the ac voltage which is pulsed from the dc voltage source 6 by way of the thyristors 7 through 7′″, at the primary-side coil of the transformer 3. By virtue of the transformer action, the secondary side of the coil involves the ac voltage shown in FIG. 6b, of the current strength I₂ shown in FIG. 6c. The voltage U_{L} is formed as shown in FIG. 6d at the electrode 1 by the high-voltage cascade and the rectifying action at the secondary side. That voltage is constant over the entire time configuration of the corona discharge and as soon as the corona limit is exceeded it is also never again below the corona limit U_{K}. FIG. 6f again shows the pulse currents from FIG. 5e, but downstream of the filter 27 in FIG. 3.

1. An ignition arrangement for a combustion machine, which provides a corona discharge for ignition of a fuel/air mixture in the combustion chamber of the combustion machine, wherein said ignition arrangement delivers a basic voltage which is always different from zero for triggering and maintaining the corona discharge for each ignition process.

2. An ignition arrangement as set forth in claim 1 further comprising a transformer, wherein provided on the primary side of the transformer is a voltage source which delivers alternating current or a varying DC voltage.

3. An ignition arrangement as set forth in claim 2 wherein a voltage multiplier is provided on the secondary side of the transformer.

4. An ignition arrangement as set forth in claim 2 wherein a voltage smoother is arranged on the secondary side of the transformer.

5. An ignition arrangement as set forth in claim 4 wherein the voltage smoother is a half-wave rectifier.

6. An ignition arrangement as set forth in claim 4 wherein the voltage smoother is a multi-wave rectifier.

7. An ignition arrangement as set forth in claim 1 wherein there is provided a control device or regulating device.

8. An ignition arrangement as set forth in claim 7 wherein the control device or regulating device keeps the voltage on the secondary side of the transformer substantially constant.

9. An ignition arrangement as set forth in claim 7 wherein the regulating device regulates the voltage on the secondary side of the transformer to a reference value.

10. An ignition arrangement as set forth in claim 9 wherein recourse is additionally made to at least one engine parameter for regulation purposes.

11. An ignition arrangement as set forth in claim 10 wherein the at least one engine parameter is selected from the group of ignition time, ignition duration or combinations thereof.

12. An ignition arrangement as set forth in claim 7 wherein the control device or regulating device always keeps the basic voltage below the breakdown voltage for an arc discharge.

13. An ignition arrangement as set forth in claim 7 wherein the control device or regulating device always keeps the basic voltage above the corona limit.

14. A method of igniting a fuel/air mixture in the combustion chamber of a combustion machine, by means of a corona discharge, wherein a basic voltage which is always different from zero is provided for triggering and maintaining the corona discharge.

15. A combustion machine having an ignition arrangement as set forth in claim 1.

16. A stationary power installation including a generator, a combustion machine and an ignition arrangement as set forth in claim 1.
